(19) United States
(12) Patent Application Publication
(10) Pub. No.: US 2015/0050029 A1
(43) Pub. Date: Feb. 19, 2015

(54) OPERATING VERTICAL-CAVITY SURFACE-EMITTING LASERS

(71) Applicants: Dacheng Zhou, Fort Collins, CO (US); Daniel A. Berkram, Loveland, CO (US); Zhubiao Zhu, Fort Collins, CO (US)

(72) Inventors: Dacheng Zhou, Fort Collins, CO (US); Daniel A. Berkram, Loveland, CO (US); Zhubiao Zhu, Fort Collins, CO (US)

(21) Appl. No.: 14/387,264

(22) PCT Filed: Apr. 25, 2012
(86) PCT No.: PCT/US12/34950

§ 371 Date: Sep. 23, 2014

(51) Int. Cl. H04B 10/564; G06F 1/32; H04B 10/27

(52) U.S. Cl. CPC H04B 10/564; H04B 10/27; G06F 1/3296
USPC 398/162

(57) ABSTRACT

Methods, systems, and computer-readable media are provided for operating a vertical cavity surface-emitting laser. Operating a vertical-cavity surface-emitting laser can include receiving an optical signal from a transmitter, converting the optical signal to a waveform, generating a read capture window based on the waveform, sampling data at a first position in the read capture window, sampling data at a second position in the read capture window, and sending a signal to the transmitter to increase a power level of the optical signal in response to a difference between the sampled data at the first position and the sampled data at the second position exceeding a threshold.

### BACKGROUND

Optical power in a vertical-cavity surface-emitting laser (VCSEL) can vary (e.g., as temperature changes). To reduce power consumption and/or increase reliability of VCSELs, power may be controlled automatically, in some instances.

### BRIEF DESCRIPTION OF THE DRAWINGS

FIG. 1 illustrates a block diagram of an example of a system for operating a VCSEL in accordance with the present disclosure.

FIG. 2 illustrates a block diagram of an example of a computing system including a computer-readable medium in communication with processing resources for operating a VCSEL in accordance with the present disclosure.

FIGS. 3A-3B illustrate examples of data patterns and read capture windows in accordance with the present disclosure.

FIG. 4 is a flow chart illustrating an example of a method for operating a VCSEL in accordance with the present disclosure.

### DETAILED DESCRIPTION

Examples of the present disclosure include methods, systems, and/or computer-readable media. An example method for operating a VCSEL can include receiving an optical signal from a transmitter, converting the optical signal to a waveform, generating a read capture window based on the waveform, sampling data at a first position in the read capture window, sampling data at a second position in the read capture window, and sending a signal to the transmitter to increase a power level of the optical signal in response to a difference between the sampled data at the first position and the sampled data at the second position exceeding a threshold.

Existing techniques for automatically controlling power may include e use of monitoring systems (e.g., external systems) employing a monitoring laser and/or monitoring photodiode. Such systems may additionally include complicated circuits which may further increase costs. Further, such systems may rely on assumptions that various characteristics between the monitoring system and VCSEL system are shared (e.g., operating temperature, mechanical alignment, and/or aging behavior).

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

For various semiconductor diodes, junction voltage at a fixed current can decrease as temperature increases. For example, junction voltage in a VCSEL can vary in such a manner (e.g., by −2-mV/° C.). Accordingly, as temperature increases, VCSEL modulated optical power can decrease as threshold current for stimulated emission increases. Such a decrease can be visualized by a slope efficiency curve flattening with increased temperature in a conceptual I-P curve illustrating a relationship between driving current and optical power in a VCSEL. Automatic power control schemes can maintain substantially constant optical power in the face of various changing conditions including, for example, temperature, component age, and/or alignment, among others.

Examples of the present disclosure do not use costly monitoring laser(s) and/or monitoring photodiode(s). Accordingly, examples of the present disclosure can save costs associated with such components, installation of such components, and/or additional complicated circuits that may be associated therewith.

Additionally, examples of the present disclosure can avoid using assumptions of model parameters. For example, monitoring voltage via a monitoring system may require knowledge of various parameters as well as their behaviors over various temperatures and/or over ages. Such knowledge may be costly to gain, and may vary from one VCSEL system to another. Accordingly, examples of the present disclosure can cover various (e.g., all) parts of a VCSEL system, photodiode, and/or path variations (e.g., alignment of transmitter and/or receiver and/or aging).

Additionally, examples of the present disclosure can use data from a VCSEL system itself rather than data from a number of monitoring systems. As a result, examples of the present disclosure can avoid issues associated with differing characteristic between multiple systems. Further, examples of the present disclosure can be implemented with reduced (e.g., minimal) changes to hardware (e.g., circuits) resulting in reduced space and/or power, for instance, compared to previous approaches to optical power control.

Examples of the present disclosure can monitor a read capture window associated with a received optical signal while the optical signal is being received. Further, examples of the present disclosure can compare data (e.g., data of the optical signal) sampled at a first position (e.g., a center of the read capture window) with data captured at a second position (e.g., at a periphery of the read capture window). Accordingly, examples of the present disclosure can determine a change (e.g., a collapse) of the read capture window.

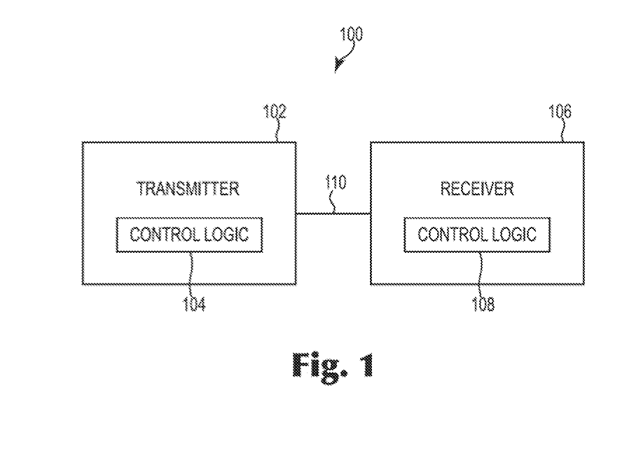

A collapse of the read capture window can be caused, for example, by a change (e.g., decrease) in an output power of a transmitter (e.g., transmitter 102, discussed below in connection with FIG. 1) and/or a change in a sensitivity of a receiver (e.g., receiver 106, discussed below in connection with FIG. 1), among other causes. Changes in the receiver and/or transmitter can result from variations in temperature, age of various components, and/or alignment of various components, for instance, among other factors.

Examples of the present disclosure can, for example, adjust (e.g., increase and/or decrease) power level(s) of a transmitter in response to a determined change in the read capture window. For example, examples of the present disclosure can adjust an output signal swing and/or common mode voltage associated with a transmitter. Accordingly, examples of the present disclosure can dynamically reduce (e.g., minimize) power usage, increasing VCSEL life and reliability, while still ensuring sufficient optical power to maintain transmission reception integrity.

FIG. 1 illustrates a block diagram of an example of a system 100 for operating a VCSEL in accordance with the present disclosure. As shown in FIG. 1, system 100 includes a transmitter 102 including control logic 104, and a receiver 106, including control logic 108. Though not illustrated in FIG. 1, system 100 can include additional components, such as a number of amplifiers, for instance, among others. As shown in FIG. 1, transmitter 102 and receiver 106 can be connected by channel 110. Channel 110 can be a fiber optical channel, for instance. Though one channel is illustrated, transmitter 102 and receiver 106 can reside in separate sub-networks within an optical network such that they may be in separate interconnected rings and/or in a mesh network that may be coupled together by a number of optical fibers, for instance.

Transmitter 102 can be a VCSEL diode (e.g., semiconductor laser diode with laser transmission perpendicular to its top surface). For example, transmitter 102 can transmit an optical signal (e.g., transmission, light wave and/or pulse) at various power levels (e.g., optical power levels). Various operations of transmitter 102 (e.g., transmission power level control) can be controlled by control logic 104, for instance.

Receiver 106 can be a device and/or module (e.g., a photodetector) configured to receive an optical signal from transmitter 102. For example, receiver 106 can be positioned to receive an optical signal directed toward receiver 106 from transmitter 102. Receiver 106 can be of various types including, for example a positive, intrinsic, and negative photodiode and/or resonant cavity photodetector, among others.

Control logic 104 and/or control logic 108 can be implemented in the form of, for example, hardware logic (e.g., in the form of application specific integrated circuits (ASICs)). However, examples of the present disclosure are not limited to a particular implementation of control logic 104 and/or control logic 108 unless otherwise indicated. Communication between transmitter 102 and receiver 106 (e.g., between control logic 104 and control logic 108) can include various encoding(s) and/or protocol(s). Further, communication can include communication via a low speed bus (e.g., system control bus, Ethernet etc.), for instance, among others.

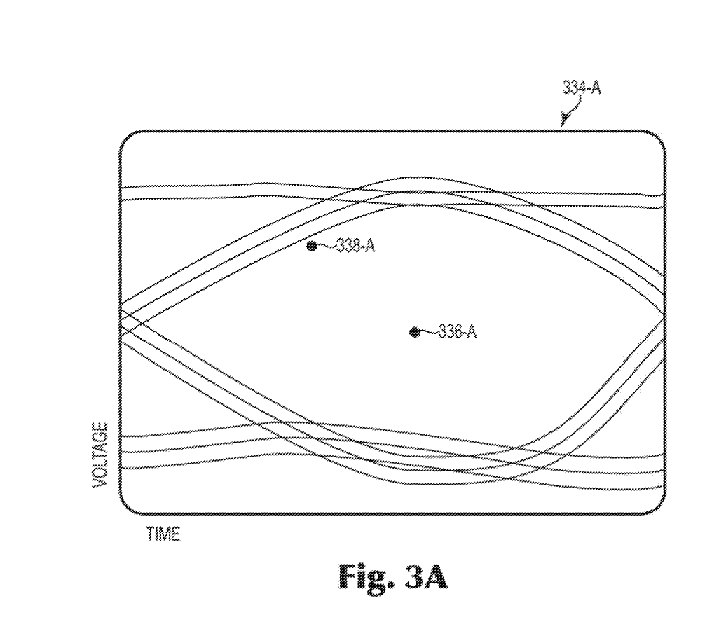

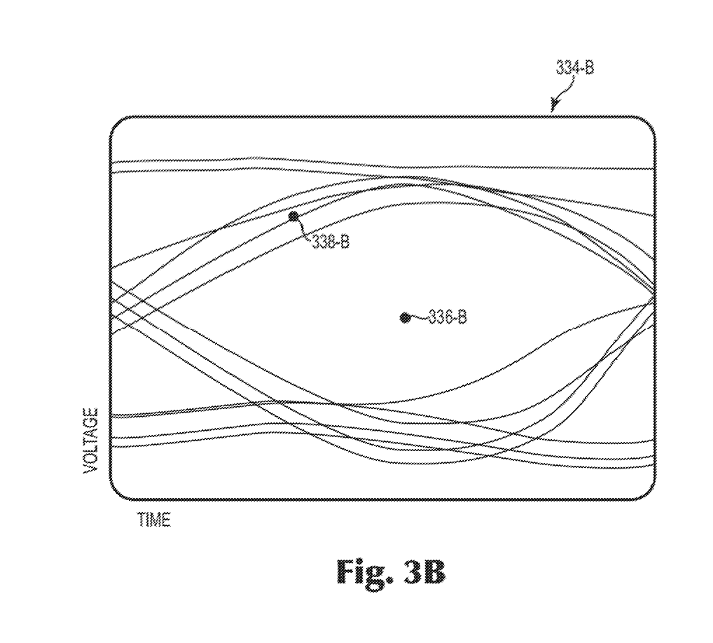

Control logic 108 can examine (e.g., read) the received optical signal and convert the optical signal to a waveform. Based on the received optical signal and/or the waveform, control logic 108 can generate a read capture window. Two example read capture windows in accordance with the present disclosure are illustrated by FIGS. 3A and 3B, and additionally discussed below. Control logic 108 can sample data at various positions (e.g., read capture points, locations, etc.) within the read capture window. Such positions can indicate where various data should be latched, for instance. For example, control logic 108 can sample data at a sampling point substantially in the center of an “optical eye” (e.g., when the eye is “open”). Examples of such a point are illustrated in FIGS. 3A and 3B as sampling point 336-A and sampling point 336-B, respectively. A substantially central position can be selected to allow for control logic 108 to distinguish between a high and low signal for each bit of the received optical signal, for instance.

Additionally, control logic 108 can sample data from a second position with respect to the read capture window. A second position, as used herein, can refer to another position, a different position, an additional position, etc. Further, and as discussed below, examples of the present disclosure do not limit the sampling of data to a particular number of positions with respect to a read capture window.

The second position can be referred to as a reference point (illustrated in FIGS. 3A and 3B as reference point 338-A and 338-B), for example. As illustrated in FIGS. 3A and 3B, the second position can differ in voltage and/or time from the sampling point. The second position can be selected based on a shape of the read capture window resulting from a transmission of an optical signal from transmitter 102 determined (e.g., known) to be sufficient for reliable reception (e.g., reception of sufficient integrity and/or quality). For example, control logic 108 can determine that a reception is sufficiently reliable if it exceeds a particular threshold (e.g., bit error rate), for instance. Accordingly, the second position can be selected as being at the periphery of a read capture window associated with a reliable optical signal, for instance.

Control logic 108 can compare the data sampled from the first position with the data sampled from the second position, and can make various determinations based on the comparison between the different data. For example, at a particular power level, the read capture window can represent a reliable optical signal (e.g., as previously discussed, and as illustrated in FIG. 3A. for instance). Control logic can determine that data sampled from the first position matches data sampled at the second position. Based on that determination, control logic 108 can determine that the power level is sufficient for reliable reception, for instance.

As previously discussed, a read capture window can change (e.g., due to temperature change). One example of such a change is a collapsing of the “optical eye” of the read capture window. A collapse, as previously discussed, can indicate a change (e.g., reduction) in an input signal power of receiver 106. A collapse of the “optical eye” is illustrated in FIG. 3B, for example. Control logic 108 can determine that a difference between data sampled from the first position (e.g., sampling point 336-B) and data sampled from the second position (e.g., reference point 338-B) exceeds a threshold. Exceeding a threshold can include, for example, a particular amount and/or portion of the data differing and/or respective bit error rates associated with the data differing by a particular amount (e.g., by 10⁻⁴).

For example, control logic 108 can request transmitter 102 to increase a transmission power (e.g., output power) of the transmission, without interrupting the transmission, in response to the sampled data from the first position (e.g., the substantially central location) exceeding the threshold (e.g., being different than the sampled data from the peripheral location (e.g., the second position)). Increasing the transmission power can include increasing a current (e.g., output current) of transmitter 102. Increasing transmission power can include increasing optical power to a particular level (e.g., desired operating power) and/or by a particular portion and/or amount (e.g., 10%). Such a level can be selected based on a determination that receiver 106 will receive a sufficient signal at the particular level, and, at the same time, the power level at the particular level would be adequately low such that system 100 avoids reliability problems associated with increased (e.g., high) power, such as those due to aging and/or stress, for instance.

Additionally, such a level can be determined based on an expected rate of failure of the optical signal and/or reception of the optical signal. Such a rate of failure can be measured by a bit error rate (e.g., a bit error rate of the received data pattern with respect to a predefined data pattern). The optical power of the signal from transmitter 102 can be increased such that an expected bit error rate is at a particular level (e.g., 10⁻¹²) and/or falls within a particular range (e.g., 10⁻¹⁰-10⁻¹⁶) and/or signal integrity margin. Additionally, such a level can be determined based on an expected time until failure.

A location within a read capture window of the second position can be selected based on a desired voltage and/or time offset. Additionally, and as previously discussed, data can be sampled at a number of positions. For example, a third position (not shown in FIGS. 3A and/or 3B) can be selected (e.g., nearer the periphery of the read capture window than the first and second positions). Accordingly, control logic 108 can adjust the power level of transmitter 102 such that a difference between the sampled data at the first and second positions and the sampled data at the third position exceeds a threshold (e.g., the sampled data at the first and second positions is different than the sampled data at the third position). Examples of the present disclosure can sample data at various positions allowing for fine-tuning of optical power of transmitter 102, by, for example, adjusting (e.g., increasing and/or decreasing) an output current of transmitter 102.

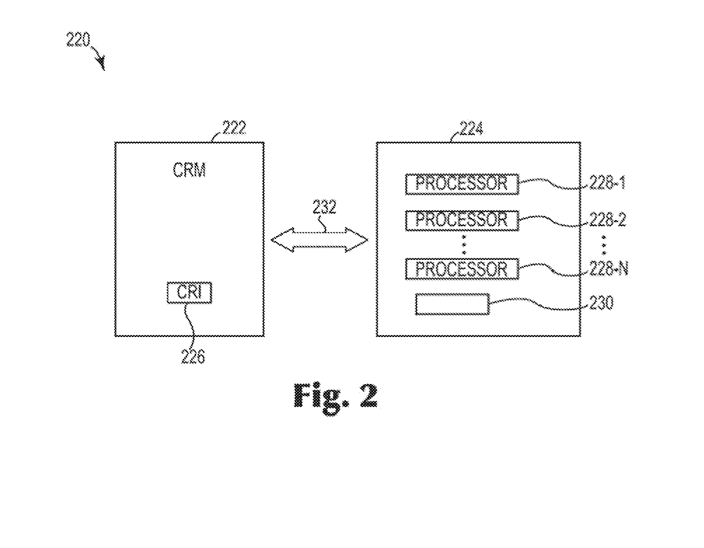

FIG. 2 illustrates a block diagram 220 of an example of a computing system including a computer-readable medium in communication with processing resources for operating a VCSEL in accordance with the present disclosure. Computer-readable medium (CRM) 222 can be in communication with a computing device 224 having processor resources of more or fewer than 228-1, 228-2, . . . , 228-N, that can be in communication with, and/or receive a tangible non-transitory CRM 222 storing a set of computer-readable instructions 226 executable by one or more of the processor resources (e.g., 228-1, 228-2, . . . , 228-N) for operating a VCSEL as described herein. The computing device may include memory resources 230, and the processor resources 228-1, 228-2, . . . , 228-N may be coupled to the memory resources 230.

Processor resources can execute computer-readable instructions 226 for operating a VCSEL that are stored on an internal or external non-transitory CRM 222. A non-transitory CRM (e.g., CRM 222), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

Non-transitory CRM 222 can be integral, or communicatively coupled, to a computing device, in either in a wired or wireless manner. For example, non-transitory CRM 222 can be an internal memory, a portable memory, a portable disk, or a memory located internal to another computing resource (e.g., enabling the computer-readable instructions to be downloaded over the Internet).

CRM 222 can be in communication with the processor resources (e.g., 228-1, 228-2, . . . , 228-N) via a communication path 232. The communication path 232 can be local or remote to a machine associated with the processor resources 228-1, 228-2, . . . , 228-N. Examples of a local communication path 232 can include an electronic bus internal to a machine such as a computer where CRM 222 is one of volatile, non-volatile, fixed, and/or removable storage medium in communication with the processor resources (e.g., 228-1, 228-2, . . . , 228-N) via the electronic bus. Examples of such electronic buses can include Industry Standard Architecture (ISA), Peripheral Component Interconnect (PCI), Advanced Technology Attachment (ATA), Small Computer System interface (SCSI), Universal Serial Bus (USB), among other types of electronic buses and variants thereof.

Communication path 232 can be such that CRM 222 is remote from the processor resources (e.g., 228-1, 228-2, . . . , 228-N) such as in the example of a network connection between CRM 222 and the processor resources (e.g., 228-1, 228-2, . . . , 228-N). That is, communication path 232 can be a network connection. Examples of such a network connection can include a local area network (LAN), a wide area network (WAN), a personal area network (PAN), and the Internet, among others. In such examples, CRM 222 may be associated with a first computing device and the processor resources (e.g., 228-1, 228-2, . . . , 228-N) may be associated with a second computing device.

Computer-readable instructions 226 can include instructions to generate a read capture window based cm an optical signal from a vertical-cavity surface-emitting laser transmitter. Such a generation can be in a manner analogous to that previously discussed in connection with FIG. 1, and/or illustrated by FIGS. 3A and/or 3B, for instance. Computer-readable instructions 226 can include instructions to sample data at a first position in the read capture window in a manner analogous to that as previously discussed in connection with FIG. 1, and at an example location illustrated in FIGS. 3A and/or 3B, for instance. Computer-readable instructions 226 can include instructions to sample data at a second position in the read capture window in a manner analogous to that as previously discussed in connection with FIG. 1, and at an example location illustrated in FIGS. 3A and/or 3B, for instance. Computer-readable instructions 226 can include instructions to adjust an output current associated with the optimal signal in response to the sampled data at the first position being different than the sampled data at the second position in a manner analogous to that previously discussed in connection FIG. 1, for example.

FIGS. 3A-3B illustrate examples of data patterns and read capture windows in accordance with the present disclosure. For example, FIG. 3A illustrates a read capture window (e.g., eye diagram) 334-A of a received optical signal (e.g., received by receiver 106, previously discussed in connection with FIG. 1) at a particular (e.g., normal and/or reliable) input signal power level. FIG. 3B illustrates a read capture window 334-B of the received optical signal at a different (e.g., reduced) input signal power level. As shown in FIG. 3B, the “optical eye” associated with the different power level is “collapsed” (e.g., reduced in size) in comparison to the “optical eye” associated with the particular input signal power level illustrated in FIG. 3A.

As illustrated in FIGS. 3A and 3B, read capture window 334-A and read capture window 334-B each include a sampling point, illustrated as a sampling point 336-A and a sampling point 336-B, respectively. Further, FIGS. 3A and 3B each include a reference point, illustrated as a reference point 338-A and a reference point 338-B, respectively. Sampling point 336-A, sampling point 336-B, reference point 338-A and/or reference point 338-B can be set, selected, and/or adjusted by control logic (e.g., control logic 108 previously discussed in connection with FIG. 1) to provide for various desired time and/or voltage offsets, as previously discussed.

For example, Sampling point 336-A and/or sampling point 336-B can be selected such that they are located substantially in the center of the read capture window (e.g., where the eye is “open”) such that the control logic can distinguish between a high and low signal for each bit of the received optical signal. Further, and as illustrated in FIGS. 3A and 3B, reference point 338-A and/or reference point 338-B can be selected such that they are located on a periphery (e.g., edge) of read capture window 334-A and 334-B, respectively.

Although one sampling point and one reference point are shown in FIGS. 3A and 3B, examples of the present disclosure do not limit the selection of sampling points and/or reference points to a particular number. Additionally, though particular locations of the sampling points and reference points are illustrated, examples of the present disclosure do not limit the location of such points to a particular location with respect to read capture window 334-A and/or read capture window 334-B.

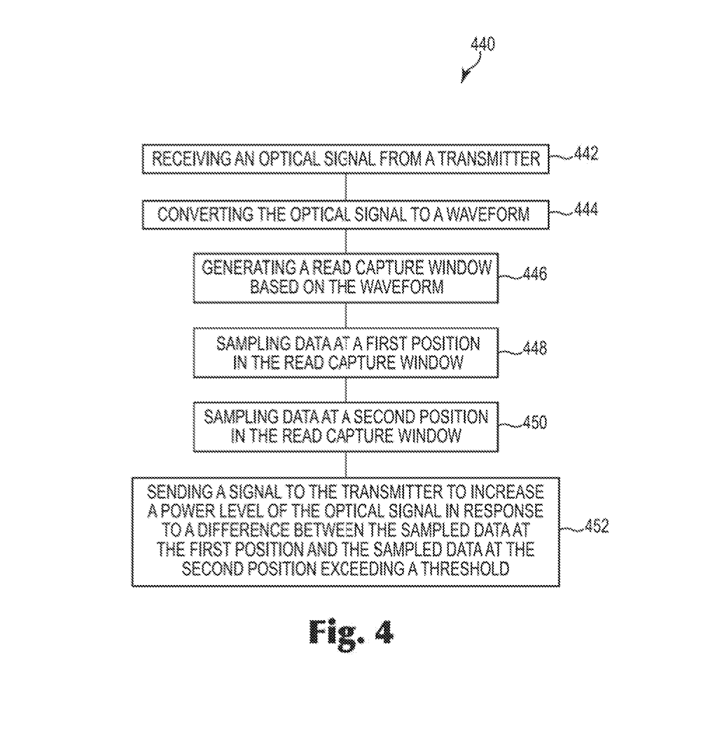

FIG. 4 is a flow chart illustrating an example of a method 440 for operating a VCSEL in accordance with the present disclosure. Method 440 can be performed by a number of hardware devices and/or a number of computing devices executing computer-readable instructions (e.g., the computing system discussed above in connection with FIG. 2).

At block 442, method 440 includes receiving an optical signal from a transmitter. An optical signal can be received in various manners such as, for example, those previously discussed in connection with FIG. 1.

At block 444 method 440 includes converting the optical signal to a waveform. The optical signal can be converted in a manner analogous to that previously discussed in connection with FIG. 1, for instance.

At block 446, method 440 includes generating a read capture window based on the waveform. A read capture window (e.g., read capture window 334-A and/or read capture window 334-B, previously discussed in connection with FIGS. 1, 3A and/or 3B) can be generated in a manner analogous to that previously discussed in connection with FIG. 1, for instance.

At block 448, method 440 includes sampling data at a first position (e.g., sampling point 336-A and/or sampling point 336-B, previously discussed in connection with FIGS. 1, 3A, and/or 3B) in the read capture window. Data can be sampled at the first position in a manner analogous to that previously discussed in connection with FIG. 1, for instance.

At block 450, method 440 includes sampling data at a second position (e.g., reference point 333-A and/or reference point 338-B, previously discussed in connection with FIGS. 1, 3A, and/or 3B) in the read capture window. Data can be sampled at the second position in a manner analogous to that previously discussed in connection with FIG. 1, for instance.

At block 452, method 440 includes sending a signal to the transmitter (e.g., transmitter 102, previously discussed in connection with FIG. 1) to increase a power level of the optical signal in response to a difference between the sampled data at the first position and the sampled data at the second position exceeding a threshold. Such a power level can be increased in a manner analogous to that previously discussed in connection with FIG. 1, for example.

Method 440 can be performed at various stages of operation of a VCSEL (e.g., continuously and/or according to a schedule). Additionally, method 440 can be performed without an interruption of a transmission of a VCSEL signal

The above specification, examples data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A method of operating a vertical-cavity surface-emitting laser, comprising:
receiving an optical signal from a transmitter;
converting the optical signal to a waveform;
generating a read capture window based on the waveform;
sampling data at a first position in the read capture window;
sampling data at a second position in the read capture window; and
sending a signal to the transmitter to increase a power level of the optical signal in response to a difference between the sampled data at the first position and the sampled data at the second position exceeding a threshold.

2. The method of claim 1, wherein the first position is substantially a center of the read capture window.

3. The method of claim 1, wherein the second position is between a center of the read capture window and an edge of the read capture window.

4. The method of claim 1, wherein exceeding the threshold includes the sampled data at the first position being different than the sampled data at the second position.

5. The method of claim 1, wherein exceeding the threshold includes the sampled data at the first position differing from the sampled data at the second position by at least a particular amount.

6. The method of claim 1, wherein the method includes sampling data at a third position in the read capture window, wherein the third position is nearer a periphery of the read capture window than the first and second positions.

7. The method of claim 1, wherein the method includes sampling data at a third position in the read capture window and adjusting the power level of the optical signal such that the sampled data at the first and second positions is different than the sampled data at the third position.

8. A non-transitory computer-readable medium comprising instructions stored thereon executable by a processor to:
generate a read capture window based on optical signal from a vertical-cavity surface-emitting laser transmitter;
sample data at a first position in the read capture window;
sample data at a second position in the read capture window; and
adjust an output current associated with the optical signal in response to the sampled data at the first position being different than the sampled data at the second position.

9. The non-transitory computer-readable medium of claim 8, wherein the instructions include instructions to increase the output current in response to the sampled data at the first position being different than the sampled data at the second position.

10. The non-transitory computer-readable medium of claim 8, wherein the instructions include instructions to decrease the output current by a particular portion of the output current.

11. The non-transitory computer-readable medium of claim 8, wherein the instructions include instructions to adjust the output current associated with the optical signal in response to a difference between a respective bit error rate associated with each of the data sampled at the first position and the data sampled at the second position.

12. A system for operating a vertical-cavity surface-emitting laser, comprising:
a vertical-cavity surface-emitting laser transmitter to transmit a transmission; and
a vertical-cavity surface-emitting laser receiver to receive the transmission including control logic to:
generate a read capture window based on the received transmission while the transmission is being received;
sample data from a substantially central in the read capture window;
sample data from peripheral location in the read capture window; and
request the transmitter to increase a transmission power of the transmission, without interrupting the transmission, in response to the sampled data from the substantially central location being different than the sampled data from the peripheral location.

13. The system of claim 12, wherein the vertical-cavity surface-emitting laser receiver includes control logic to select the peripheral location based on a particular voltage offset from the central location.

14. The system of claim 12, wherein the vertical-cavity surface-emitting laser receiver includes control logic to select the peripheral location in the read capture window while the transmission is being transmitted at a particular power level.

15. The system of claim 12, herein the vertical-cavity surface-emitting laser receiver includes control logic to select the peripheral location in the read capture window in response to a bit error rate, associated with the transmission while the transmission is being received, exceeding a threshold.
